(19) United States
(12) Patent Application Publication
(10) Pub. No.: US 2022/0248705 A1
(43) Pub. Date: Aug. 11, 2022

(54) Edible Confectionery Ink Composition for 3D-Printing

(71) Applicant: Bunge Loders Croklaan B.V., Wormerveer (NL)

(72) Inventors: Hendrikus Mulder, Wormerveer (NL); Helen Cornelia Smit, Wormerveer (NL); Jun Ma, Wormerveer (NL)

(73) Assignee: Bunge Loders Croklaan B.V., Wormerveer (NL)

(21) Appl. No.: 17/617,630

(22) PCT Filed: Jun. 8, 2020
(86) PCT No.: PCT/EP2020/065848

§ 371 Date: Dec. 9, 2021

(30) Foreign Application Priority Data
Jun. 12, 2019 (EP) 19179737.2

(51) Int. Cl. A23G 3/34; A23G 1/00; A23G 1/38; A23G 1/40; A23G 1/46; A23G 1/50; A23G 3/40; A23G 3/42; A23G 3/46; A23G 3/50; A23D 9/007

(52) U.S. Cl. CPC A23G 3/0027; A23G 1/0066; A23G 1/38; A23G 1/40; A23G 1/46; B33Y 70/00; A23G 3/40; A23G 3/42; A23G 3/46; A23G 3/50; A23D 9/007; A23G 1/50

(57) ABSTRACT

An edible confectionery ink composition for 3D printing comprises: from 20% to 75% by weight of sweetener, preferably sugar, and from 15% to 50% by weight of a fat composition, wherein the fat composition comprises from 45% to 65% by weight of lauric acid (C12:0); and from 15% to 25% by weight of total palmitic acid (C16:0) and stearic acid (C18:0); said percentages of acid referring to acids bound as acyl groups in glycerides in the fat composition and being based on the total weight of C8 to C24 fatty acids; and wherein the fat composition has from 80 to 100 solid fat content at 20° C.; and from 70 to 98 solid fat content at 25° C.; and from 30 to 60 solid fat content at 30° C.; measured on unstabilized fat according to ISO 8292-1.

This invention relates to an edible confectionery ink composition for 3D-printing, the use thereof, a 3D-printed confectionery product and a method for making an edible confectionery ink composition for 3D-printing.

### BACKGROUND

Customized food products have become more and more popular, such as personalized chocolate bars or chocolate-like confectionery products. Since customized food products are often required in a limited quantity, the production cost of these products is relatively high for a food manufacturer if these products are produced in traditional ways such as by molding or by skilled artisans.

3D food printing provides a potential solution to improve the efficiencies to produce custom-designed food products while the product cost could be reduced to an acceptable and accessible level for consumers.

3D food printing techniques include inkjet printing, powder binding deposition and fused deposition modelling (FDM). Inkjet printing technology employs a thermal or piezoelectric head to generate the pressure necessary to push droplets out of the nozzle. Powder binding deposition includes selective laser sintering, selective hot air sintering and melting and liquid binding. The application of FDM is commonly seen in printing soft-materials like purees, as well as molten chocolate and hydrogel-forming materials. The food ink is loaded in an extruder/syringe. Using a printing head having movements that are digitally controlled, the ink is deposited onto a platform as the result of a force exerted by a piston.

EP A1 0 462 093 relates to a method for preparing confectionery products printed with edible ink, in particular printed chocolate and an ink to be used therein, which contains at least a solvent, a suspended pigment, a sugar and a surfactant and preferably also a lipophilic substance and an emulsifier.

WO 2014/139966 relates to processes for printing with edible inks and printing an edible ink onto a material using an inkjet printing device. The material may be an edible material. The ink may comprise a colorant, at least 30% water, at least 25% carbohydrate sweeteners and be free from both diols and triols.

WO 2013/068154 relates to a process for producing a decorated coated frozen confection product, the process comprising the steps of: applying a layer of a coating material to a frozen confection; and ink-jet printing a fat-based ink onto the coated frozen confection to form a pattern; wherein the fat-base of the ink is a fat or blend of fats having N10 values of at least 70.

EP A1 1 551 930 discloses high resolution ink jet printing on edible substrates in which fat or wax-based edible inks, which contain a colorant, a fat or wax dispersible carrier, and a fat or wax base, are used to produce high resolution images on edible products. The methods utilize a piezoelectric print head; and the edible products include confectionery pieces having non-planar, hydrophobic surfaces, such as wax-polished sugar shell surfaces, with a printed image thereon having a resolution greater than 100 dpi, preferably greater than 300 dpi.

GB 1441446A relates to methods of decorating confectionery by applying an edible ink composition thereto.

WO 2016/150960 relates to food compositions which contain specific texturing agents and to the use of said food compositions in a 3D printing process.

WO 2016/168421 discloses an edible material made of liquid, sugar, and one or more hydrocolloids. The edible material may be used to form edible cups, containers, and the like, may be capable of holding hot or cold liquids for extended periods of time, and have an extended shelf life. The composition forming the edible material may further be suitable for 3D printing edible applications.

EP A1 2 727 469 relates to a method for printing a three-dimensional crystalline structure such as a chocolate layer wherein, after printing, the material has a desired crystal structure.

EP A1 2 937 206 describes a method for printing a three-dimensional crystalline structure such as a chocolate layer wherein, after printing, the material has a desired crystal structure and a plurality of non-random cavities.

CN 107410628A discloses 3D-printing quick-shaping fondant food materials. The fondant food materials comprise the following raw materials in percentage by mass: 25%-30% of candyfloss, 55%-60% of icing, 6%-10% of butter, 4%-6% of corn syrup, 0.5%-1% of tylose powder and 1.5%-3% of white oil.

There remains a need to provide an edible confectionery ink composition which is suitable for a 3D-printing process and to obtain a printed product with improved stable structure and desirable appearance properties. There also remains a need to provide a feasible and efficient 3D printing method with a suitable edible ink to print a three-dimensional edible confectionery object.

### DESCRIPTION OF THE INVENTION

According to the present invention, there is provided an edible confectionery ink composition for 3D printing comprising from 20% to 75% by weight of sweetener and from 15% to 50% by weight of a fat composition, wherein the fat composition comprises from 45% to 65% by weight of lauric acid (C12:0); and from 15% to 25% by weight of total palmitic acid (C16:0) and stearic acid (C18:0); said percentages of acids referring to acids bound as acyl groups in glycerides in the fat composition and being based on the total weight of C8 to C24 fatty acids; and wherein the fat composition has from 80 to 100 solid fat content at 20° C.; and from 70 to 98 solid fat content at 25° C.; and from 30 to 60 solid fat content at 30° C.; measured on unstabilized fat according to ISO 8292-1.

The edible confectionery ink of this invention has been found to be particularly useful for 3D food printing. An edible confectionery ink according to the invention has a good texture and viscosity before printing so that the ink can be smoothly extruded out of a nozzle. After deposition on a platform, the ink is still able to maintain an outstandingly stable and rigid structure that easily allows further processing and/or packaging. The printed object is also relatively close to the predetermined design. In particular, the ink according to the invention surprisingly provides good appearance properties in a 3D printed product.

The term “3D printing” refers to an automated process in which material is connected or solidified to produce a predetermined three-dimensional object with material being added together, layer by layer.

The term “edible” refers to something suitable for use as food or as part of a food product, such as a confectionery product.

The term “confectionery” refers to an edible food product comprising sweetener, such as sweets (candy) and chocolates.

The term “ink composition” refers to a fluid paste material prepared by mixing ingredients, ready to be used for 3D printing and solidifying after printing to form a predesigned 3D object. The term “ink” refers to the context of use in 3D printing and does not necessarily imply the presence of a colouring agent (e.g., a dye) or colour, although the ink compositions may have a colour and may contain a colouring agent.

The term “sweetener” refers to a substance that is added to food to provide a sweet taste and is well-known in the art. Sweeteners include sucrose (also generally referred to as ‘sugar’ and which may be provided in refined or unrefined form), glucose, fructose, syrups such as corn syrup and high fructose corn syrup, honey, polyols including erythritol, maltitol, mannitol, sorbitol, lactitol, xylitol, isomalt, propylene glycol, glycerol (glycerin), threitol, galactitol and palatinose, sucralose, potassium acesulfame, acesulfame acid and salts thereof, aspartame, alitame, neotame, advantame, cyclamate, saccharin and salts thereof, neohesperidin, steviol glucosides, fruit extract and combinations thereof. Those skilled in the art will be able to adjust the amount of sweetener, or combination of sweeteners, to achieve a desired degree of sweetness. Preferred sweeteners are sucrose, glucose, fructose, syrups such as corn syrup and high fructose corn syrup. A particularly preferred sweetener is sucrose.

The term “fat” refers to glyceride fats and oils containing fatty acid acyl groups and does not imply any particular melting point. The term “oil” is used synonymously with “fat”.

The term “fatty acid”, as used herein, refers to straight chain saturated or unsaturated (including mono- and poly unsaturated) carboxylic acids having from 8 to 24 carbon atoms. The term “fatty acid” encompasses free fatty acids and fatty acid residues in glycerides. A fatty acid having x carbon atoms and y double bonds may be denoted Cx:y. For example, palmitic acid may be denoted C16:0 and oleic acid may be denoted C18:1. Percentages of fatty acids in compositions referred to herein include acyl groups in tri-, di- and mono-glycerides present in the glycerides and are based on the total weight of C8 to C24 fatty acids. The fatty acid profile (i.e., composition) may be determined, for example, by fatty acid methyl ester analysis (FAME) using gas chromatography according to ISO 12966-2 and ISO 12966-4.

The fat composition of the edible confectionery ink composition according to the invention may be made from naturally occurring or synthetic fats, fractions of naturally occurring or synthetic fats, or mixtures thereof, that satisfy the requirements for fatty acids and solid fat contents defined herein. Preferably, the fat composition is, or is derived from, one or more vegetable fats, optionally hydrogenated.

The ink composition of the invention comprises from 20% to 75% by weight of sweetener, preferably from 25% to 70% by weight, more preferably from 35% to 60% by weight and even more preferably from 43% to 55% by weight.

The ink composition of the invention further comprises from 15% to 50% by weight of the fat composition, preferably from 20% to 45% by weight, more preferably from 25% to 40% by weight, and even more preferably from 25% to 34% by weight.

Accordingly, a preferred ink composition of the invention comprises from 25% to 70% by weight of sweetener and from 20% to 45% by weight of the fat composition. A more preferred ink composition of the invention comprises from 35% to 60% by weight of sweetener and from 25% to 40% by weight of the fat composition. An even more preferred ink composition of the invention comprises from 43% to 55% by weight of sweetener and from 25% to 34% by weight of a fat composition.

An even more preferred ink composition of the invention comprises from 25% to 70% by weight of sugar and from 20% to 45% by weight of the fat composition. A more preferred ink composition of the invention comprises from 35% to 60% by weight of sugar and from 25% to 40% by weight of the fat composition. An even more preferred ink composition of the invention comprises from 43% to 55% by weight of sugar and from 25% to 34% by weight of the fat composition.

The fat composition of an ink composition according to the invention preferably has from 85% to 100% by weight of saturated fatty acids (SAFA), more preferably from 88% to 100% by weight; said percentages of acid referring to acids bound as acyl groups in glycerides in the fat composition and being based on the total weight of C8 to C24 fatty acids.

The fat composition of an ink composition according to the invention preferably has a weight ratio of oleic acid (C18:1):(total palmitic acid (C16:0) and stearic acid (C18:0)) of from 0.01 to 0.55, more preferably from 0.01 to 0.45, even more preferably from 0.01 to 0.40; said percentages of acid referring to acids bound as acyl groups in glycerides in the fat composition and being based on the total weight of C8 to C24 fatty acids.

The fat composition of an ink composition according to the invention comprises from 45% to 65% by weight of lauric acid (C12:0), preferably from 50% to 60% by weight, more preferably from 50% to 55% by weight; said percentages of acid referring to acids bound as acyl groups in glycerides in the fat composition and being based on the total weight of C8 to C24 fatty acids.

The total palmitic acid (C16:0) and stearic acid (C18:0) of the fat composition of an ink composition according to the invention is from 15% to 25%, preferably from 16% to 23%, more preferably from 17% to 21%; said percentages of acid referring to acids bound as acyl groups in glycerides in the fat composition and being based on the total weight of C8 to C24 fatty acids.

Accordingly, the fat composition of an ink composition according to the invention comprises preferably from 50% to 60% by weight of lauric acid (C12:0) and from 16% to 23% by weight of total palmitic acid (C16:0) and stearic acid (C18:0); said percentages of acid referring to acids bound as acyl groups in glycerides in the fat composition and being based on the total weight of C8 to C24 fatty acids. The fat composition of an ink composition according to the invention comprises more preferably from 50% to 55% by weight of lauric acid (C12:0) and from 17% to 21% by weight of total palmitic acid (C16:0) and stearic acid (C18:0); said percentages of acid referring to acids bound as acyl groups in glycerides in the fat composition and being based on the total weight of C8 to C24 fatty acids.

In a preferred embodiment, the fat composition of an ink composition according to the invention comprises from 50% to 60% by weight of lauric acid (012:0); and from 16% to 23% by weight of total palmitic acid (C16:0) and stearic acid (C18:0); and from 92% to 100% by weight of saturated fatty acids (SAFA); and a weight ratio of oleic acid (C18:1):(total palmitic acid (C16:0) and stearic acid (018:0)) of from 0.01 to 0.55.

In a more preferred embodiment, the fat composition of an ink composition according to the invention comprises from 50% to 55% by weight of lauric acid (C12:0); and from 17% to 21% by weight of total palmitic acid (C16:0) and stearic acid (C18:0); and from 93% to 100% by weight of saturated fatty acids (SAFA); and a weight ratio of oleic acid (C18:1):(total palmitic acid (C16:0) and stearic acid (C18:0)) of from 0.01 to 0.45.

The fat composition of an ink composition according to the invention preferably comprises from 0.0% to 7.0% by weight of oleic acid (C18:1), more preferably from 0.1% to 6.0% by weight.

The fat composition of an ink composition according to the invention has from 80 to 100 solid fat content at 20° C.; and from 70 to 98 solid fat content at 25° C.; and from 30 to 60 solid fat content at 30° C.; measured on unstabilized fat according to ISO 8292-1.

Preferably, the fat composition of an ink composition of the invention has from 85 to 100 solid fat content at 20° C., more preferably from 90 to 98; measured on unstabilized fat according to ISO 8292-1.

Preferably, the fat composition of an ink composition of the invention has from 75 to 96 solid fat content at 25° C., more preferably from 78 to 94; measured on unstabilized fat according to ISO 8292-1.

Preferably, the fat composition of an ink composition of the invention has from 35 to 58 solid fat content at 30° C., more preferably from 40 to 55; measured on unstabilized fat according to ISO 8292-1.

Preferably, the fat composition of an ink composition of the invention has from 1 to 7 solid fat content at 35° C., more preferably from 1 to 5; measured on unstabilized fat according to ISO 8292-1.

In a preferred embodiment, the fat composition of an ink composition of the invention has from 85 to 100 solid fat content at 20° C.; and from 75 to 96 solid fat content at 25° C.; and from 35 to 58 solid fat content at 30° C.; and from 1 to 7 solid fat content at 35° C.; measured on unstabilized fat according to ISO 8292-1.

In a more preferred embodiment, the fat composition of an ink composition of the invention has from 90 to 98 solid fat content at 20° C.; and from 78 to 94 solid fat content at 25° C.; and from 40 to 55 solid fat content at 30° C.; and from 1 to 5 solid fat content at 35° C.; measured on unstabilized fat according to ISO 8292-1.

It is believed that the edible ink compositions have particularly desired rheological properties to be extruded out of a nozzle smoothly and controllably during printing and be deposited on a platform when the fat composition of the ink compositions has a solid fat content at 30° C. and/or at 35° C. within the preferred ranges.

It is also believed that the edible ink compositions provide a particularly stable and rigid structure of 3D printed product after being deposited on a platform when the fat composition of the ink compositions has a solid fat content at 20° C. and/or at 25° C. within the preferred ranges.

In a preferred embodiment, the fat composition of an ink composition of the invention comprises hydrogenated lauric oil selected from palm kernel oil, palm kernel oil fractions, coconut oil, coconut oil fractions and mixtures thereof.

The term “lauric oil” refers to glyceride fats and oils comprising predominantly short- and medium chain fatty acid (caprylic acid (C8:0), capric acid (C10:0), lauric acid (C12:0) and myristic acid (C14:0)), for example, coconut oil, palm kernel oil, babassu oil, cohune oil and cuphea oil.

In a more preferred embodiment, the fat composition of an ink composition of the invention comprises hydrogenated palm kernel oil. In an even more preferred embodiment, the fat composition of an ink composition of the invention comprises from 50% to 100% by weight of hydrogenated palm kernel oil.

In another preferred embodiment, the fat composition of an ink composition according to the invention comprises sorbitan tristearate. More preferably, the fat composition of an ink composition according to the invention comprises from 0.5% to 5.0% by weight sorbitan tristearate. Even more preferably, the fat composition of an ink composition according to the invention comprises from 1.0% to 3.0% by weight sorbitan tristearate. The appearance of 3D-printed product is particularly desirable when the fat composition of the ink composition comprises from 1.0% to 3.0% by weight sorbitan tristearate.

In another more preferred embodiment, the fat composition of an ink composition according to the invention comprises hydrogenated palm kernel oil and sorbitan tristearate.

The fat composition of an ink composition of the invention is alternatively preferably non-hydrogenated. The term “non-hydrogenated” means that the composition is not prepared from a fat that has been subjected to hydrogenation to convert unsaturated fatty acyl groups to saturated fatty acyl groups. The requirement for the fat to be non-hydrogenated means that the content of trans fatty acid residues in the composition is typically less than 1% by weight based on total C8 to C24 fatty acids present, more preferably less than 0.5% by weight.

In another preferred embodiment, an edible confectionery ink composition for 3D printing comprises from 20% to 75% by weight of sweetener and from 15% to 50% by weight of a non-hydrogenated fat composition, wherein the non-hydrogenated fat composition comprises from 45% to 65% by weight of lauric acid (C12:0); and from 15% to 25% by weight of total palmitic acid (C16:0) and stearic acid (C18:0); said percentages of acid referring to acids bound as acyl groups in glycerides in the fat composition and being based on the total weight of C8 to C24 fatty acids; and wherein the fat composition has from 80 to 100 solid fat content at 20° C.; and from 70 to 98 solid fat content at 25° C.; and from 30 to 60 solid fat content at 30° C.; measured on unstabilized fat according to ISO 8292-1.

In another more preferred embodiment, the edible confectionery ink composition for 3D printing according to the invention comprises from 20% to 75% by weight of sweetener and from 15% to 50% by weight of a non-hydrogenated fat composition, wherein the non-hydrogenated fat composition comprises from 45% to 65% by weight of lauric acid (C12:0); and from 15% to 25% by weight of total palmitic acid (C16:0) and stearic acid (C18:0); and from 85% to 96% by weight of saturated fatty acid (SAFA); said percentages of acid referring to acids bound as acyl groups in glycerides in the fat composition and being based on the total weight of C8 to C24 fatty acids; and wherein the fat composition has from 80 to 100 solid fat content at 20° C.; and from 70 to 98 solid fat content at 25° C.; and from 30 to 60 solid fat content at 30° C.; measured on unstabilized fat according to ISO 8292-1.

In another even more preferred embodiment, the edible confectionery ink composition for 3D printing according to the invention comprises from 20% to 75% by weight of sweetener and from 15% to 50% by weight of a non-hydrogenated fat composition, wherein the non-hydrogenated fat composition comprises from 45% to 65% by weight of lauric acid (C12:0); and from 15% to 25% by weight of total palmitic acid (C16:0) and stearic acid (C18:0); and from 88% to 95% by weight of saturated fatty acid (SAFA); said percentages of acid referring to acids bound as acyl groups in glycerides in the fat composition and being based on the total weight of C8 to C24 fatty acids; and wherein the fat composition has from 80 to 100 solid fat content at 20° C.; and from 70 to 89 solid fat content at 25° C.; and from 35 to 58 solid fat content at 30° C.; measured on unstabilized fat according to ISO 8292-1.

Using a non-hydrogenated fat composition in an edible confectionery ink composition is alternatively preferred because the non-hydrogenated fat composition not only reduces the health risk due to the presence of trans fatty acids but also reduces the amount of saturated fatty acids. As is well known in the art, saturated fats may be undesirable from a nutritional point of view. Saturated fats may also reduce the flavor release and mouthfeel of products. In a preferred alternative embodiment, the edible confectionery ink compositions comprising a non-hydrogenated fat composition still have a good and acceptable fluidity and viscosity before printing and provide a firm and acceptable structure of 3D-printed product with a good appearance after being deposited on a platform.

In another preferred embodiment, the fat composition of an ink composition according to the invention comprises palm kernel stearin prepared by double fractionation and palm stearin prepared by double fractionation (also referred to as palm kernel super stearin and palm super stearin, respectively). Fractionation may be dry fractionation, solvent fraction or detergent fractionation as well known in the field of oils and fats. The term “double fractionation” refers to a two-stage fractionation of oil or fat. The preferred fractionation is dry fractionation that is well known in the art. Palm kernel super stearin produced by double fractionation preferably has an iodine value from 3 to 7, more preferably from 4 to 6. Palm super stearin prepared by double fractionation preferably has an iodine value from 8 to 20, more preferably from 10 to 15. The term “iodine value” refers to the number of grams of iodine that could be added to 100 g of oil, which can be measured by a standard method, such as AOCS Method Cd 1-25.

The edible confectionery ink composition according to the invention preferably comprises further one or more optional ingredients selected from cocoa powder, milk powder, vegetable milk powder, dairy powder, yoghurt powder, cocoa mass, vanillin, emulsifier, colorant and flavoring.

The edible confectionery ink composition according to the invention preferably comprises from 5% to 25% by weight of cocoa powder, more preferably from 6% to 20% by weight.

In another preferred aspect, the edible confectionery ink composition according to the invention comprises from 0.1% to 1% by weight of colorant, more preferably from 0.1% to 0.5% by weight.

The term “emulsifier” refers to a substance kinetically increasing the stability of an emulsion, for example, lecithin, polyglycerol polyricinoleate (PGPR), sorbitan tristearate, sorbitan monostearate, mono- and diglycerides, distilled monoglycerides and propylene glycol esters of fatty acids.

Further provided by the invention is a method for making an edible confectionery ink composition suitable for 3D printing, comprising the steps of: a) providing a fat composition according to the invention; b) melting completely the fat composition provided in step a); c) blending sweetener and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 20% to 75% by weight of sweetener and from 15% to 50% by weight of the fat composition from step a) and b); d) mixing the blend obtained from step c) at a temperature of from 50° C. to 65° C.; e) cooling the mixture obtained from step d) to a temperature of from 28° C. to 40° C., wherein the ink composition is fluid. The ink composition is fluid at the end of the method at the temperature of 28° C. to 40° C. such that it can be used in 3D printing.

The invention also relates to the use of an edible confectionery ink composition according to the invention for 3D printing.

The invention also relates to a method for printing a 3D edible confectionery product, comprising the steps of: a) providing a fat composition, wherein the fat composition comprises: from 45% to 65% by weight of lauric acid (C12:0); and from 15% to 25% by weight of total palmitic acid (C16:0) and stearic acid (C18:0); said percentages of acid referring to acids bound as acyl groups in glycerides in the fat composition and being based on the total weight of C8 to C24 fatty acids; and wherein the fat composition has: from 80 to 100 solid fat content at 20° C.; and from 70 to 98 solid fat content at 25° C.; and from 30 to 60 solid fat content at 30° C.; measured on unstabilized fat according to ISO 8292-1; b) melting completely the fat composition provided in step a); c) blending sugar or other sweetener and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 20% to 75% by weight of sweetener and from 15% to 50% by weight of the fat composition from steps a) and b); d) mixing the blend obtained from step c) at a temperature of from 50° C. to 65° C.; e) cooling the ink obtained from step d) to a temperature of from 27° C. to 40° C., wherein the ink is fluid; f) depositing the fluid ink according to a predetermined three-dimensional pattern comprising multiple layers; g) solidifying the fluid ink on a platform at a solidifying temperature.

The term “solidifying temperature” refers to a temperature at which the ink composition solidifies on a platform. The solidifying temperature for an edible composition ink is in general from 15° C. to 28° C., preferably from 18° C. to 25° C.

Preferably, the fat composition provided in step a) of the method according to the invention has from 50% to 60% by weight of lauric acid (C12:0) and from 16% to 23% by weight of total palmitic acid (C16:0) and stearic acid (C18:0); said percentages of acid referring to acids bound as acyl groups in glycerides in the fat composition and being based on the total weight of C8 to C24 fatty acids.

More preferably, the fat composition provided in step a) of the method according to the invention has from 50% to 55% by weight of lauric acid (C12:0) and from 17% to 21% by weight of total palmitic acid (C16:0) and stearic acid (C18:0); said percentages of acid referring to acids bound as acyl groups in glycerides in the fat composition and being based on the total weight of C8 to C24 fatty acids.

Preferably, the fat composition provided in step a) of the method according to the invention has from 85 to 100 solid fat content at 20° C.; measured on unstabilized fat according to ISO 8292-1. More preferably, the fat composition provided in step a) of the method according to the invention has from 90 to 98 solid fat content at 20° C.; measured on unstabilized fat according to ISO 8292-1.

Preferably, the fat composition provided in step a) of the method according to the invention has from 75 to 96 solid fat content at 25° C.; measured on unstabilized fat according to ISO 8292-1. More preferably, the fat composition provided in step a) of the method according to the invention has from 78 to 94 solid fat content at 25° C.; measured on unstabilized fat according to ISO 8292-1.

Preferably, the fat composition provided in step a) of the method according to the invention has from 35 to 58 solid fat content at 30° C.; measured on unstabilized fat according to ISO 8292-1. More preferably, the fat composition provided in step a) of the method according to the invention has from 40 to 55 solid fat content at 30° C.; measured on unstabilized fat according to ISO 8292-1.

Preferably, the fat composition provided in step a) of the method according to the invention has from 1 to 7 solid fat content at 35° C.; measured on unstabilized fat according to ISO 8292-1. More preferably, the fat composition provided in step a) of the method according to the invention has from 1 to 5 solid fat content at 35° C.; measured on unstabilized fat according to ISO 8292-1.

In a preferred embodiment, the fat composition provided in step a) of the method according to the invention has from 85 to 100 solid fat content at 20° C.; and from 75 to 96 solid fat content at 25° C.; and from 35 to 58 solid fat content at 30° C.; and from 1 to 7 solid fat content at 35° C.; measured on unstabilized fat according to ISO 8292-1.

In a more preferred embodiment, the fat composition provided in step a) of the method according to the invention has from 90 to 98 solid fat content at 20° C.; and from 78 to 94 solid fat content at 25° C.; and from 40 to 55 solid fat content at 30° C.; and from 1 to 5 solid fat content at 35° C.; measured on unstabilized fat according to ISO 8292-1.

The blend obtained from step c) according to the method is mixed preferably at a temperature of from 52° C. to 62° C. in step d), more preferably at a temperature of from 53° C. to 58° C.

The mixture obtained from step d) according to the method is cooled preferably to a temperature of from 27° C. to 37° C., more preferably to a temperature of from 29° C. to 36° C., even more preferably to a temperature of from 30° C. to 35° C.

In a preferred embodiment, the method for printing a 3D edible confectionery product according to the invention comprises the step of: a) providing a fat composition, wherein the fat composition comprises: from 50% to 60% by weight of lauric acid (C12:0); and from 16% to 23% by weight of total palmitic acid (C16:0) and stearic acid (C18:0); said percentages of acid referring to acids bound as acyl groups in glycerides in the fat composition and being based on the total weight of C8 to C24 fatty acids; and wherein the fat composition has: from 85 to 100 solid fat content at 20° C.; and from 75 to 96 solid fat content at 25° C.; and from 35 to 58 solid fat content at 30° C.; and from 1 to 7 solid fat content at 35° C.; measured on unstabilized fat according to ISO 8292-1; b) melting completely the fat composition provided in step a); c) blending sugar or other sweetener and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 25% to 70% by weight of sweetener and from 20% to 45% by weight of the fat composition from steps a) and b); d) mixing the blend obtained from step c) at a temperature of from 52° C. to 62° C.; e) cooling the ink obtained from step d) to a temperature of from 27° C. to 37° C., wherein the ink is fluid; f) depositing the fluid ink according to a predetermined three-dimensional pattern comprising multiple layers; g) solidifying the fluid ink on a platform at a solidifying temperature.

In a more preferred embodiment, the method for printing a 3D edible confectionery product according to the invention comprises the step of: a) providing a fat composition, wherein the fat composition comprises: from 50% to 55% by weight of lauric acid (C12:0); and from 17% to 21% by weight of total palmitic acid (C16:0) and stearic acid (C18:0); said percentages of acid referring to acids bound as acyl groups in glycerides in the fat composition and being based on the total weight of C8 to C24 fatty acids; and wherein the fat composition has: from 90 to 98 solid fat content at 20° C.; and from 78 to 94 solid fat content at 25° C.; and from 40 to 55 solid fat content at 30° C.; and from 1 to 5 solid fat content at 35° C.; measured on unstabilized fat according to ISO 8292-1; b) melting completely the fat composition provided in step a); c) blending sugar or other sweetener and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 35% to 60% by weight of sweetener and from 25% to 40% by weight of the fat composition from steps a) and b); d) mixing the blend obtained from step c) at a temperature of from 53° C. to 58° C.; e) cooling down the ink obtained from step d) to a temperature of from 29° C. to 36° C., wherein the ink is fluid; f) depositing the fluid ink according to a predetermined three-dimensional pattern comprising multiple layers; g) solidifying the fluid ink on a platform at a solidifying temperature.

In another preferred embodiment, the method for printing a 3D edible confectionery product according to the invention comprises the step of: a) providing a non-hydrogenated fat composition, wherein the non-hydrogenated fat composition comprises from 45% to 65% by weight of lauric acid (C12:0); and from 15% to 25% by weight of total palmitic acid (C16:0) and stearic acid (C18:0); and from 85% to 96% by weight of saturated fatty acid (SAFA); said percentages of acid referring to acids bound as acyl groups in glycerides in the fat composition and being based on the total weight of C8 to C24 fatty acids; and wherein the fat composition has from 80 to 100 solid fat content at 20° C.; and from 70 to 98 solid fat content at 25° C.; and from 30 to 60 solid fat content at 30° C.; measured on unstabilized fat according to ISO 8292-1; b) melting completely the fat composition provided in step a); c) blending sugar or other sweetener and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 25% to 70% by weight of sweetener and from 20% to 45% by weight of the fat composition from steps a) and b); d) mixing the blend obtained from step c) at a temperature of from 52° C. to 62° C.; e) cooling the ink obtained from step d) to a temperature of from 27° C. to 37° C., wherein the ink is fluid; f) depositing the fluid ink according to a predetermined three-dimensional pattern comprising multiple layers; g) solidifying the fluid ink on a platform at a solidifying temperature.

The invention also relates to a 3D printed confectionery product obtained from, or obtainable from, the edible confectionery ink composition according to the invention.

The invention also relates to the use of a 3D printed confectionery product obtained from, or obtainable from, the edible confectionery ink composition according to the invention in an edible product.

The listing or discussion of an apparently prior-published document in this specification should not necessarily be taken as an acknowledgement that the document is part of the state of the art or is common general knowledge.

Preferences and options for a given aspect, embodiment, feature or parameter of the invention should, unless the context indicates otherwise, be regarded as having been disclosed in combination with any and all preferences and options for all other aspects, embodiments, features and parameters of the invention.

The following non-limiting examples illustrate the invention and do not limit its scope in any way. In the examples and throughout this specification, all percentages, parts and ratios are by weight unless indicated otherwise.

### EXAMPLES

### Example 1—Fat Compositions

Three fat compositions were prepared. Each fat composition was bleached and deodorized.

Fat 1 is 100% by weight of fully hydrogenated palm kernel stearin. Palm kernel stearin was produced as the stearin fraction obtained from palm kernel oil by means of dry fractionation. The palm kernel stearin was then subjected to hydrogenation until the iodine value was lower than 1. Fat 1a is a blend of 99% by weight of the fully hydrogenated palm kernel stearin and 1.0% by weight of sorbitan tristearate.

Fat 2 is a blend of 96% by weight of palm kernel super stearin obtained by double fractionation and 4% by weight of palm oil super stearin obtained by double fractionation. Palm kernel stearin was produced as the stearin fraction obtained from palm kernel oil by means of dry fractionation. Palm kernel super stearin is the stearin fraction obtained from a blend of palm kernel stearin and palm kernel oil by means of dry fractionation. The palm kernel super stearin had an iodine value from 4 to 6 measured by the AOCS Method Cd 1-25. Palm oil stearin is the stearin fraction obtained from palm oil by means of dry fractionation. Palm oil super stearin is the stearin fraction obtained from palm oil stearin also by means of dry fractionation. Double fractionated palm oil stearin has an iodine value from 10 to 15 measured by the AOCS Method Cd 1-25.

Two comparative fat compositions were prepared. Each comparative fat composition was also bleached and deodorized.

Comparative Fat 1 is 100% by weight of palm kernel stearin.

Comparative Fat 2 is a blend of 60% by weight of palm kernel stearin and 40% by weight of coconut oil.

The analytical results of Fat 1, Fat 1a, Fat 2, Comparative Fat 1 and Comparative Fat 2 are shown in Table 1.

TABLE 1
Analytical results of Fat 1, Fat 1a, Fat 2,
Comparative Fat 1 and Comparative Fat 2

| | | | | Comparative | Comparative |
|---|---|---|---|---|---|
| | Fat 1 | Fat 1a | Fat 2 | Fat 1 | Fat 2 |
| US-N20 | 96 | 95 | 91 | 83 | 66 |
| US-N25 | 90 | 90 | 80 | 66 | 38 |
| US-N30 | 50 | 50 | 47 | 29 | 0 |
| US-N35 | 4 | 3 | 2 | 0 | 0 |
| US-N40 | 1 | 0 | 0 | 0 | 0 |
| C8:0 | 1.7 | 1.6 | 1.1 | 1.6 | 3.2 |
| C10:0 | 2.6 | 2.6 | 2.2 | 2.6 | 3.5 |
| C12:0 | 54.2 | 54.0 | 50.9 | 52.6 | 49.0 |
| C14:0 | 21.3 | 21.6 | 22.0 | 22.5 | 19.8 |
| C16:0 | 9.1 | 9.5 | 15.0 | 9.4 | 11.1 |
| C18:0 | 10.3 | 9.7 | 2.4 | 2.5 | 3.2 |
| C18:1 | 0.3 | 0.7 | 5.2 | 7.3 | 8.4 |
| C18:2 | 0.1 | 0.0 | 0.8 | 1.1 | 1.5 |
| C18:3 | 0.0 | 0.0 | 0.0 | 0.0 | 0.0 |
| C20:0 | 0.2 | 0.2 | 0.1 | 0.1 | 0.1 |
| SAFA | 99.5 | 99.2 | 93.9 | 91.4 | 90.0 |
| MUFA | 0.3 | 0.7 | 5.2 | 7.4 | 8.4 |
| PUFA | 0.1 | 0.0 | 0.8 | 1.1 | 1.5 |
| IV FAME | 0.4 | 0.7 | 5.8 | 8.2 | 9.9 |
| C16:0 + C18:0 | 19.4 | 19.2 | 17.4 | 11.9 | 14.3 |
| C18:1/(C16:0 + | 0.02 | 0.04 | 0.30 | 0.61 | 0.59 |
| C18:0) | | | | | |

In the above table:

Cx:y refers to a fatty acid having x carbon atoms and y double bonds; levels determined by GC-FAME (ISO 12966-2 and ISO 12966-4);

IVFAME refers to calculated iodine value according to AOCS Method Cd 1c-85;

SAFA refers to saturated fatty acids;

MUFA refers to monounsaturated fatty acids;

PUFA refers to polyunsaturated fatty acids;

US-Nx refers to solid fat content determined by NMR on unstabilised fat at x° C. (ISO 8292-1).

### Example 2—Preparation of Confectionery Ink Composition

Each fat composition in Example 1 (Fat 1, Fat 1a, Fat 2, Comparative Fat 1 and Comparative Fat 2) was completely melted in a stainless steel container immersed in a 55° C. water bath for at least 3 hours.

For each confectionery ink composition, a pre-mixture of 1440 gram sugar, 210 gram cocoa powder DR 74, 210 gram cocoa powder NE, 210 gram skimmed milk powder, 12 gram lecithin and 0.6 gram vanillin was prepared and kept at room temperature. 930 gram of each completely melted fat composition was then added into the pre-mixture respectively and blended.

A laboratory ball mill (W-1-S, Wiener B. V., the Netherlands) was prepared and thermostated at 55° C. with a water bath. Subsequently, each blend containing all the ingredients in Table 2 was added to the ball mill respectively and the total contents were milled at maximum speeds for 40 minutes. The ball mill was then set at minimum speed and each material was collected from the outlet of the mill into a stainless steel container respectively.

TABLE 2
Recipe of confectionery ink composition

| Ingredient | Weight (gram) | Percentage (%) |
|---|---|---|
| Sugar | 1440 | 47.80% |
| Fat composition | 930 | 30.87% |
| Cocoa powder DR 74 (Cargill | 210 | 6.97% |
| Cocoa & Chocolate) | | |
| Cocoa powder NE (Cargill | 210 | 6.97% |
| Cocoa & Chocolate) | | |
| Skimmed milk powder | 210 | 6.97% |
| Lecithin | 12 | 0.40% |
| Vanillin | 0.6 | 0.02% |

Each collected material was kept in stainless steel containers immersed in a water bath set at 55° C. The container was then placed into a water bath of 15° C.-16° C. and while stirring, each material was cooled to a temperature of 32° C.-35° C. Five confectionery ink compositions were then obtained (Table 3).

TABLE 3
Overview of confectionery ink compositions

| | Confectionery ink composition | | | | |
|---|---|---|---|---|---|
| | Ink | Ink | Ink | Comparative ink | Comparative ink |
| | composition 1 | composition 1a | composition 2 | composition 1 | composition 2 |
| Fat | Fat 1 | Fat 1a | Fat 2 | Comparative | Comparative |
| composition | | | | Fat 1 | Fat 2 |

### Example 3—3D-Printing of Confectionery Products

Each confectionery ink composition in Example 2 was subsequently loaded into a preheated 30 mL plastic syringe—extruder (diameter of 23 mm, 40° C.). This syringe was immediately placed in a Byflow Focus 3D food printer (Byflow, The Netherlands) which was equipped with a heating element to maintain the syringe at a controlled temperature of 33-35° C. 3D-printing was initiated and model prints were made consisting of a square shape with single wall of 160 by 160 mm and 10 layers high. This predetermined pattern was made in Sketchup and translated into a G-code file by Slic3r software. Extrusion diameter of the printing nozzle was 1.6 mm and vertical printing velocity set at 15 mm/s for all layers. A single brim was printed at 10 mm from the object in the beginning in order to allow the printer to adjust the necessary force to extrude the ink out of the syringe. Layer height was set at 1.2 mm for all prints. Five 3D-printed confectionery products were then obtained respectively (Table 4).

TABLE 4
Overview of 3D-printed confectionery products

| | 3D-printed confectionery product | | | | |
|---|---|---|---|---|---|
| | | | | Comparative | Comparative |
| | 3D-printed | 3D-printed | 3D-printed | 3D-printed | 3D-printed |
| | product 1 | product 1a | product 2 | product 1 | product 2 |
| Confectionery | Ink | Ink | Ink | Comparative ink | Comparative ink |
| ink | composition 1 | composition 1a | composition 2 | composition 1 | composition 2 |
| composition | | | | | |

### Example 4—Evaluation of 3D-Printed Confectionery Products

All the ink compositions have an acceptable viscosity in the extruder and are able to be extruded smoothly out of the syringe and be deposited on the platform with a constant printing speed. After printing, the weight and the height of each product were measured. The results are shown in Table 5.

TABLE 5
Weight and height of each product after 3D-printing

| | 3D-printed confectionery product | | | | |
|---|---|---|---|---|---|
| | | | | Comparative | Comparative |
| | 3D-printed | 3D-printed | 3D-printed | 3D-printed | 3D-printed |
| | product 1 | product 1a | product 2 | product 1 | product 2 |
| Weight (g) | 23.0 | 23.2 | 22.8 | 23.9 | 23.5 |
| Height (mm) | 13 | 14 | 13 | 6 | 6 |

It was observed that the heights of 3D-printed confectionery product 1, 1a and 2 were quite close to the design value 12 mm (1.2 mm×10 layers), which means that the structure after printing was considerably similar to what has been designed. The low height value is because of object structure collapsing after printing due to the too slow crystallization behavior of the ink composition. Clearly, an ink composition of slow crystallization is less suitable for 3D printing.

The rigidness of each 3D-printed confectionery product was directly evaluated after printing. The rigidness evaluation is shown in Table 6.

TABLE 6
Rigidness evaluation of 3D-printed confectionery products

| | 3D-printed confectionery product | | | | |
|---|---|---|---|---|---|
| | | | | Comparative | Comparative |
| | 3D-printed | 3D-printed | 3D-printed | 3D-printed | 3D-printed |
| | product 1 | product 1a | product 2 | product 1 | product 2 |
| Rigidness | hard | hard | hard, but | soft | very soft and |
| | | | slightly | | liquid |
| | | | flexible | | |
| Layer | good | good | good | no separation | no separation |
| separation | separation | separation | separation | | |

The structures of Comparative 3D-printed product 1 and Comparative 3D-printed product 2 are too soft and unstable. On the contrary, 3D-printed product 2 is hard and stable although slightly flexible. 3D-printed product 1 and 3D-printed product 1a are hard and desirable. Layer separation was nice and good in all 3D-printed products 1 to 3 while no layer separation occurred in Comparative 3D-Printed Products 1-2 Due to Too Slow Solidification.

All the products were kept at room temperature for 5 months. After 5 months, the gloss and the recrystallization (blooming) of each 3D-printed confectionery product were evaluated. The evaluation is shown in Table 7.

TABLE 7
Gloss and recrystallization evaluation of 3D-printed confectionery products

| | 3D-printed confectionery product | | | | |
|---|---|---|---|---|---|
| | | | | Comparative | Comparative |
| | 3D-printed | 3D-printed | 3D-printed | 3D-printed | 3D-printed |
| | product 1 | product 1a | product 2 | product 1 | product 2 |
| Gloss | very glossy | very glossy | glossy | poor, almost | no gloss |
| | | | | no gloss | |
| Recrystallization | no | no | no | yes | yes |

No recrystallization was observed in 3D-printed product 1, 3D-printed product 1a and 3D-printed 2. Comparing to Comparative 3D-printed product 1 and Comparative 3D-printed product 2, 3D-printed product 1, 3D-printed product 1a and 3D-printed product 2 are glossy. The appearance of 3D-printed product 1a is particularly desirable.

### Example 5—3D-Printing of Dyed Confectionery Products

Each fat composition in Example 1 according to the invention (Fat 1, Fat 1a and Fat 2) was provided and completely melted in a stainless steel container immersed in a 55° C. water bath for at least 3 hours.

For each confectionery ink composition, a pre-mixture of 1320 gram sugar, 300 gram skimmed milk powder, 360 gram full cream milk powder, 18 gram lecithin, 12 gram colorant and 0.6 gram vanillin was prepared and preheated to 50° C. in a thermostated cabinet. The colorants were obtained from CHR Hansen: FruitMax® Blue 1500 OS, SweetColor® Pink 1150 OSS and Mint Green 300 OS. 930 gram of each completely melted fat composition was then added into the pre-mixture respectively and blended.

A laboratory ball mill (W-1-S, Wiener B. V., the Netherlands) was prepared and thermostated at 55° C. with a water bath. Subsequently, each blend containing all the ingredients in Table 8 was added to the ball mill respectively and the total contents were milled at maximum speeds for 40 minutes. The ball mill was then set at minimum speed and each material was collected from the outlet of the mill into a stainless steel container respectively.

TABLE 8
Recipe of dyed confectionery ink composition

| Ingredient | Weight (gram) | Percentage (%) |
|---|---|---|
| Sugar | 1320 | 43.56% |
| Fat composition | 1020 | 33.66% |
| Skimmed milk powder | 300 | 9.90% |
| Full cream milk powder | 360 | 11.88% |
| Lecithin | 18 | 0.59% |
| Colorant | 12 | 0.40% |
| Vanillin | 0.6 | 0.02% |

Each collected material was kept in a stainless steel container immersed in a water bath set at 55° C. The container was then placed into a water bath of 15° C.-16° C. and, while stirring, each material was cooled to a temperature of 32° C.-35° C.

Each dyed confectionery ink composition was subsequently loaded into a preheated 30 mL plastic syringe—extruder (diameter of 23 mm, 40° C.). This syringe was immediately placed in a Byflow Focus 3D food printer (Byflow, The Netherlands) which was equipped with a heating element to maintain the syringe at a controlled temperature of 33-35° C. 3D-printing was initiated and model prints were made consisting of a square shape with single wall of 160 by 160 mm and 10 layers high. This predetermined pattern was made in Sketchup and translated into a G-code file by Slic3r software. Extrusion diameter of the printing nozzle was 1.6 mm and vertical printing velocity was set at 15 mm/s for all layers. A single brim was printed at 10 mm from the object in the beginning in order to allow the printer to adjust the necessary force to extrude the ink out of the syringe. Layer height was set at 1.2 mm for all prints.

All the obtained 3D-printed dyed confectionery products have a nice and stable structure with desirable and bright color. The products are particularly suitable for use as decoration of an edible food product.

1. An edible confectionery ink composition for 3D printing comprising from 20% to 75% by weight of sweetener, and from 15% to 50% by weight of a fat composition, wherein the fat composition comprises:
from 45% to 65% by weight of lauric acid (C12:0); and
from 15% to 25% by weight of total palmitic acid (C16:0) and stearic acid (C18:0);
said percentages of acid referring to acids bound as acyl groups in glycerides in the fat composition and being based on the total weight of C8 to C24 fatty acids; and
wherein the fat composition has:
from 80 to 100 solid fat content at 20° C.; and
from 70 to 98 solid fat content at 25° C.; and
from 30 to 60 solid fat content at 30° C.;
measured on unstabilized fat according to ISO 8292-1.

2. The ink composition according to claim 1, comprising:
from 25% to 70% by weight of sweetener; and
from 20% to 45% by weight of the fat composition.

3. The ink composition according to claim 1, wherein the fat composition has from 85% to 100% by weight of saturated fatty acid (SAFA); said percentages of acid referring to acids bound as acyl groups in glycerides in the fat composition and being based on the total weight of C8 to C24 fatty acids.

4. The ink composition according to claim 1, wherein the fat composition has a weight ratio of oleic acid (C18:1):(palmitic acid (C16:0)+stearic acid (C18:0)) of from 0.01 to 0.50; said amounts of acid referring to acids bound as acyl groups in glycerides in the fat composition and being based on the total weight of C8 to C24 fatty acids.

5. The ink composition according to claim 1, wherein the fat composition comprises:
from 50% to 60% by weight of lauric acid (C12:0); and
from 16% to 23% by weight of total palmitic acid (C16:0) and stearic acid (C18:0);
said percentages of acid referring to acids bound as acyl groups in glycerides in the fat composition and being based on the total weight of C8 to C24 fatty acids.

6. The ink composition according to claim 1, wherein the fat composition has:
from 85 to 100 solid fat content at 20° C.; and/or
from 75 to 96 solid fat content at 25° C.; and/or
from 35 to 58 solid fat content at 30° C.; and/or
from 1 to 7 solid fat content at 35° C.;
measured on unstabilized fat according to ISO 8292-1.

7. The ink composition according to claim 1 wherein the fat composition is a hydrogenated lauric oil selected from palm kernel oil, palm kernel oil fractions, coconut oil, coconut oil fractions and mixtures thereof.

8. The ink composition according to claim 1, wherein the fat composition is a blend of non-hydrogenated palm kernel stearin and non-hydrogenated palm oil stearin.

9. The ink composition according to claim 1, further comprising one or more ingredients selected from cocoa powder, milk powder, vegetable milk powder, dairy powder, yoghurt powder, cocoa mass, vanillin, emulsifier, colorant and flavoring.

10. The ink composition according to claim 1, comprising from 5% to 25% by weight of cocoa powder.

11. A method for printing a 3D edible confectionery product comprising melting and solidifying the edible confectionery ink composition of claim 1 to form a three-dimensional pattern.

12. A method for printing a 3D edible confectionery product, comprising the steps of:
a) providing a fat composition, wherein the fat composition comprises:
from 45% to 65% by weight of lauric acid (C12:0); and
from 15% to 25% by weight of total palmitic acid (C16:0) and stearic acid (C18:0);
said percentages of acid referring to acids bound as acyl groups in glycerides in the fat composition and being based on the total weight of C8 to C24 fatty acids;
and
wherein the fat composition has:
from 80 to 100 solid fat content at 20° C.; and
from 70 to 98 solid fat content at 25° C.; and
from 30 to 60 solid fat content at 30° C.;
measured on unstabilized fat according to ISO 8292-1;
b) melting completely the fat composition provided in step a);
c) blending sweetener, preferably sugar, and optionally one or more ingredients selected from cocoa powder, milk powder, vegetable milk powder, dairy powder, yoghurt powder, cocoa mass, vanillin, emulsifier, colorant, and flavoring, with the melted liquid fat composition from step b), where the blend comprises from 20% to 75% by weight of sweetener, and from 15% to 50% by weight of the fat composition from step a) and b);
d) mixing the blend obtained from step c) at a temperature of from 50° C. to 65° C.;
e) cooling the ink obtained from step d) to a temperature of from 27° C. to 40° C., wherein the ink is fluid;
f) depositing the fluid ink from step e) according to a predetermined three-dimensional pattern comprising multiple layers; and
g) solidifying the fluid ink deposited on a platform at a solidifying temperature.

13. The method according to claim 12, wherein the fat composition provided in step a) has:
from 50% to 60% by weight of lauric acid (C12:0); and
from 16% to 23% by weight of total palmitic acid (C16:0) and stearic acid (C18:0);
said percentages of acid referring to acids bound as acyl groups in glycerides in the fat composition and being based on the total weight of C8 to C24 fatty acids.

14. The method according to claim 10, wherein the fat composition provided in step a) has:
from 85 to 100 solid fat content at 20° C.; and/or
from 75 to 96 solid fat content at 25° C.; and/or
from 35 to 58 solid fat content at 30° C.; and/or
from 1 to 7 solid fat content at 35° C.;
measured on unstabilized fat according to ISO 8292-1.

15. The method according to claim 12, wherein the blend obtained from step c) is mixed at a temperature of from 52° C. to 62° C. in step d).

16. The method according to claim 12, wherein the mixture obtained from step d) is cooled to a temperature of from 27° C. to 37° C.

17. A 3D printed confectionery product obtained from the edible confectionery ink composition of claim 1.
